(19) United States
(12) Patent Application Publication
(10) Pub. No.: US 2014/0136147 A1
(43) Pub. Date: May 15, 2014

(54) Determining System Performance

(71) Applicant: International Business Machines Corporation, Armonk, NY (US)

(72) Inventors: Paul N. Cashman, Winchester (GB); Graham White, Winchester (GB)

(73) Assignee: International Business Machines Corporation, Armonk, NY (US)

(21) Appl. No.: 14/070,797

(22) Filed: Nov. 4, 2013

(30) Foreign Application Priority Data
Nov. 9, 2012 (GB) 1220202.4

(51) Int. Cl. G06F 11/34

(52) U.S. Cl. CPC G06F 11/3409
USPC 702/182

(57) ABSTRACT

A system comprises one or more components, such as a processing device and/or a storage device and a monitoring element that is connected to at least one of the components. A mechanism of determining performance in the system determines, for each component, a maximum achievable performance for a component for a specific metric, determines a maximum performance for the component for the specific metric, given the current system configuration, determines a current performance for the component for the specific metric, and provides the determined performance measurements to the monitoring element.

### BACKGROUND

This invention relates to a method of determining system performance in a system comprised of one or more components.

Many computing products or services (hereafter systems) have an associated performance capability. When a customer or user experiences what is considered a performance issue, either real or perceived, the debug of these situations is potentially difficult and time consuming. These systems also often comprise multiple hardware and software components, potentially from different vendors, and it is quite possible for a vendor to pass the issue over to another vendor, particularly if the debug data does not immediately highlight any issue. As systems increase in complexity, with software services being applied to what used to be just hardware products, this is an increasing area of complexity for system administrators and analysts. There are currently systems available that are very good at collecting data from distributed systems and processes, for example Anaphera, but this still leaves the difficult issue of evaluating system performance.

### SUMMARY

According to a first illustrative embodiment, there is provided a method of determining system performance in a system comprised of one or more components and a monitoring element, the method comprising, for each component, the steps of determining a maximum achievable performance (pmax) for the component for the specific metric, determining a maximum performance (pmaxconfig) for the component for the specific metric, given the current system configuration, determining a current performance (pcurr) for the component for the specific metric, and providing the determined performance measurements (pmax, pmaxconfig and pcurr) to the monitoring element.

According to a second illustrative embodiment, there is provided a system comprised of one or more components and a monitoring element connected to at least one component, wherein the system, for each component, is arranged to determine a maximum achievable performance (pmax) for a component for a specific metric, determine a maximum performance (pmaxconfig) for the component for the specific metric, given the current system configuration, determine a current performance (pcurr) for the component for the specific metric, and provide the determined performance measurements (pmax, pmaxconfig and pcurr) to the monitoring element.

According to a third illustrative embodiment, there is provided a computer program product on a computer readable medium for determining system performance in a system comprised of one or more components and a monitoring element, the product comprising, for each component, instructions for determining a maximum achievable performance (pmax) for a component for a specific metric, determining a maximum performance (pmaxconfig) for the component for the specific metric, given the current system configuration, determining a current performance (pcurr) for the component for the specific metric, and providing the determined performance measurements (pmax, pmaxconfig and pcurr) to the monitoring element.

### BRIEF DESCRIPTION OF THE DRAWINGS

Preferred embodiments of the present invention will now be described, by way of example only, with reference to the following drawings, in which:

FIG. 1 is a schematic diagram of a system comprising multiple components and a monitoring element,

FIG. 2 is a schematic diagram of a fibre channel port and a monitoring element,

FIG. 3 is a flowchart of a method of determining system performance,

FIG. 4 is a schematic diagram of a network and a monitoring element,

FIG. 5 is a schematic diagram of a display device showing a visual indication of performance measurements, and

FIG. 6 is a schematic diagram of a monitoring element.

### DETAILED DESCRIPTION

Owing to the illustrative embodiments, it is possible to provide an improved system that is able to be concerned, with each component in a system, understanding and providing information for the purpose of evaluating performance. This is presented as a set of simple values for each component. The first value is a maximum achievable value under ideal circumstances, which is the maximum achievable performance (pmax). The second value is the maximum achievable value under the present configuration (pmaxconfig). The third value is the actually achieved current value (pcurr). This dataset will, therefore, indicate whether a component is running at or close to maximum and what impact other components in the system are having on performance. The values can be represented as absolute current values or may, for example in the case of the actually achieved current value (pcurr), comprise an average over a specific time period. Peak values can also be captured and retained during the monitoring process.

In an example embodiment, the system allows for an easy visual representation of the performance either locally or remotely as well as providing input for controlling higher-level operations that may either impact performance or expect a certain amount of performance. A fourth optional data value could be a delta-like value that records the impact of some external operation for future reference. This allows for a query to be applied in the future, which, for a given current workload, if a new workload was started, is able to check if the expected performance was achieved relative to the expected delta value.

The improved system, in a hardware example, can monitor a component that requires some external resource, for example CPU or buffers, such as a 10 Gbps Ethernet. The system has an understanding of the maximum achievable throughput, for example 1 GB/s, with jumbo frames in use. When used without jumbo frames, the system understands that only 70% of maximum can be achieved and reports this. The current data throughput value provides the third data point. Local analytics highlight the 70/100 mismatch via an annotation that provides feedback to a user or administrator.

Considering a hardware and software example such as current spinning disk drive technology which performs at an IO per second rate that varies according to the randomness of the IO itself, the more sequential or the more that internal drive algorithms can help, the better the IO/s rate. As an example, running random IO over a 2 GB range of a 500 GB disk is likely to exceed the theoretical maximum (based off the rotating medium, since the device can use internal algorithms to improve performance. As the range IO increases, the device becomes less and less capable of achieving the IO/s and will eventually plateau at some other value. Applying this to RAID arrays for example, a newly installed system with little allocated storage could well achieve double the IO/s of a fully allocated system with the same number of components. Using the improved performance measurements, a user will be able to see the maximum achievable performance and the maximum currently possible and understand the difference.

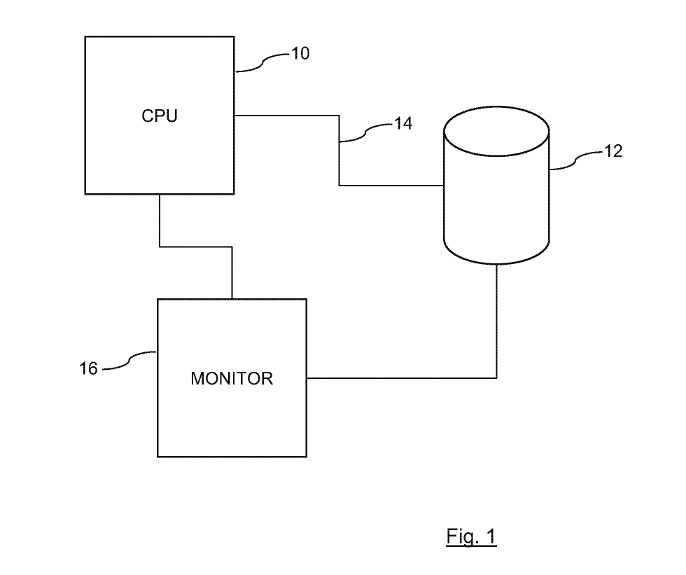

FIG. 1 shows schematically a very simple system that comprises a processing unit 10 that is connected to a storage device 12 via a wired connection 14. A monitoring element 16 is connected to the processing unit 10 and to the storage device 12. This system could form part of a much larger enterprise computing system that is composed of multiple interconnected software and hardware components. The monitoring element 16 is arranged to monitor the performance of the three components 10, 12 and 14, which are providing a specific function within the overall computing system. The monitoring clement 16 obtains various performance measurements in relation to the three components being monitored, as they are performing their normal operations. The monitoring element 16 can monitor components by being directly connected to them (as in the case of the processing unit 10 and the storage device 12) or by being indirectly connected to them (as in the case of the wired connection 14).

The monitoring element 16 obtains normalised performance metrics. One possible method by which this could be achieved is to pull or collect data as requested. This has the advantage of being unobtrusive until requested. A second possible method would be for the components being monitored to push or supply data on a regular basis. This has the advantage of providing data history. Both of these methods will supply the same data to the monitoring element 16. The performance data being acquired could be very simple data, such as data rates in terms of data handled per second, for example. Alternatively more complex data relating to specific operations could be obtained.

The data to be supplied to the monitoring element, in an illustrative embodiment, should be the number of classes of data and for each class of data, description (optional), the current value, the maximum achievable value, the maximum achievable in the current environment and configuration, the spread minimum (optional) and the spread maximum (optional). This data is for a single metric for a single component. The monitoring element 16 obtains this data for all components (which may be for the same metric or for different metrics) and can also obtain different metric data for the same component. There are many ways of rendering such data such as XML, spreadsheets and graphs, all of which can be produced by the monitoring clement 16.

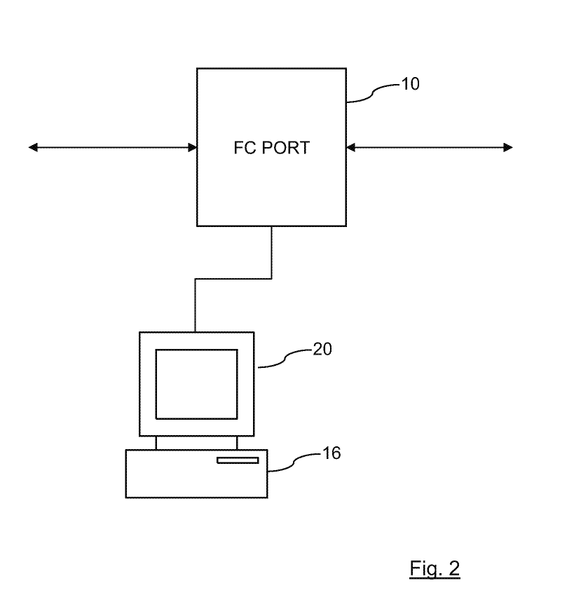

For example, the component being monitored by the monitoring element 16 may be a fibre channel port 18, as shown in FIG. 2. A port in fibre channel (FC) terminology is any entity that actively communicates over a network and is not necessarily a hardware port. The fibre channel port has six classes of data as follows: TX MB/s (transmitted data rate per second), RX MB/s (received data rate per second), TX IO/s (transmitted output transactions per second), RX IO/s (received input transactions per second), combined MB/s (total data rate per second) and combined IO/s (total input/output transactions per second). The monitoring element 16 periodically obtains data relating to these metrics from the component (either directly or indirectly) as the class data listed above. The data may be acquired every five seconds, for example, or may be triggered by a specific action.

An 8 Gb/s port might be configured at 4 Gb/s, so the maximum achievable value is 50% of a theoretical maximum value. The supplier of the performance data must have an understanding of the maximum theoretical. This can be obtained via a hard definition, for example 83% of 8 Gb/s, or by determining a value during initialisation or a similar process. During running, software code collects data about the actual TX and RX values and supply these to the monitoring element 16. An example of the way in which the data can be aggregated would be an average over the last ten seconds, for example. This means that every ten seconds performance measurements are supplied to the monitoring element 16.

The monitoring can be applied to protocol converters such a PCIe to FC device. The combined MB/s or IO/s number in such a device is representative of an internal hardware (ASIC) limitation. Both PC and PCIe are full duplex protocols. It is therefore theoretically possible for a 100% efficient device to achieve maximum TX and RX throughput simultaneously. However, that will very much depend on the hardware design and therefore capability of the ASIC manufacturer. As an example, a component can achieve 2.2 GB/s TX and 2.5 GB/s RX, and yet only achieve 2.4 GB/s full duplex, despite the fact that in theory 4.7 GB/s total ought to be achievable, and hence the system may or may not be capable of achieving 100% efficiency when in this mode of operation.

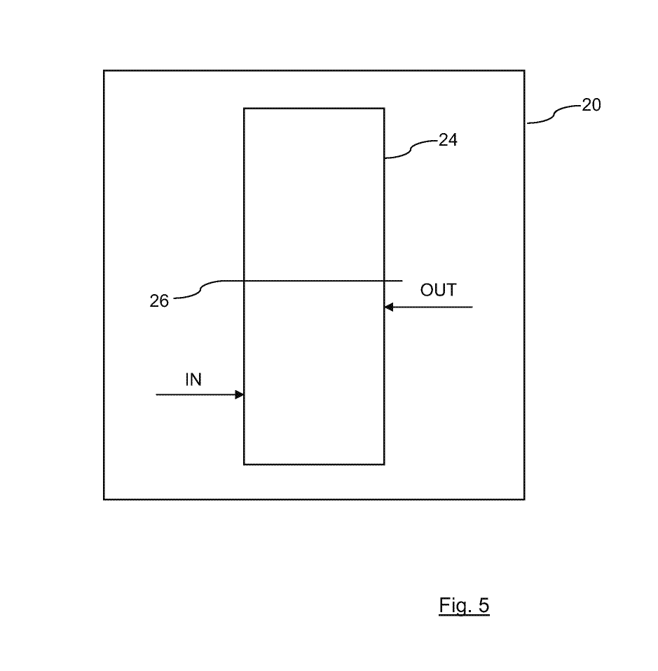

The monitoring element 16 can be provided with a display device 20 and can choose which values to render, for example via user configuration. An example would be of a performance meter, similar to a vertical bar graph, with the range of the meter representing 100% of the maximum achievable, with a fixed bar that represents the maximum achievable value in the current configuration and either (1) arrows on each side representing TX and RX respectively or (2) if only interested in one value a moving level similar to a volume display. The display device can use colours to indicate further information, for example <75% of achievable is green, 75% to 95% amber and >95% red in order to reflect that performance is perhaps limited in sonic way or close to being limited. An example of such a bar graph is shown in FIG. 5, described in detail below.

A different storage example could monitor the performance of cache utilisation using reads, where each read that requires a fetch from storage is considered a miss and otherwise a hit. A performance metric might be the ratio of read hits to the total read IOs. The output would then be 100% as a maximum and that is also the maximum achievable value in the current configuration and the current value is the ratio above as a percentage. A similar algorithm could be applied to writes. A hit is where there is sufficient cache to allow the write to occur and a miss is where data has to be de-staged to actual storage in order to create space for the write. Once again a ratio or percentage could be used to reflect efficiency.

Processor and memory can also be performance monitored. Processor performance tends to be fairly reliably fixed and predictable and can be measured by the nature of the instruction set being used, number of instructions executed per clock cycle and clock speed etc. However, there may be instances where the above principles of performance measurement apply to processors such as when they have been deliberately clocked down, for example to save power, in which case their theoretical and actual performance would differ significantly; or perhaps when they have been over-clocked which gives rise to the (possibly unique) situation where theoretical best performance might be below the actual performance. Similar principles apply to system memory.

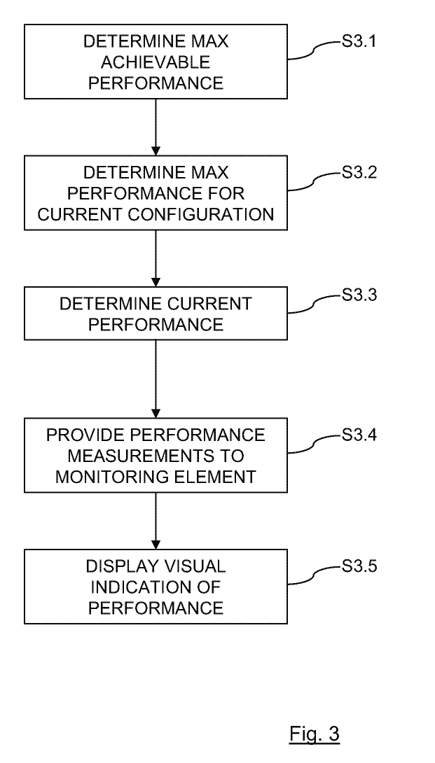

FIG. 3 shows the process of determining the system performance for a single component for a single metric. Step S3.1 comprises determining a maximum achievable performance (pmax) for the component for the specific metric, step S3.2 comprises determining a maximum performance (pmaxconfig) for the component for the specific metric, given the current system configuration, step S3.3 comprises determining a current performance (pcurr) for the component for the specific metric, step S3.4 comprises providing the determined performance measurements (pmax, pmaxconfig and pcurr) to the monitoring element and step S3.5 comprises displaying a visual indication combining the determined performance measurements (pmax, pmaxconfig and pcurr) for the given component and the given metric.

The methodology described above can also be used in network configurations. The principles of network performance measurements are similar to that already described in the storage examples, except the metric for performance is generally only Mb/s (the date rate per second) rather than considering IO/s (transactions) in addition. For networking, a typical working performance metric is roughly 80% of theoretical throughput. This is a perfect case where the theoretical maximum is not achievable but a measured actual maximum throughput is possible to achieve. The component being monitored may be the network per se, or individual hardware elements of the network infrastructure may be monitored individually. The monitoring element 16 can connect directly to the network.

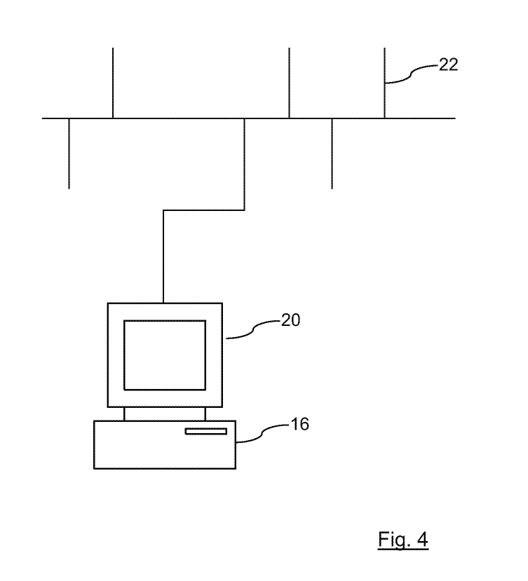

For example, in a Gigabit Ethernet environment, as shown in FIG. 4, rather than achieve a throughput of 1000 Mb/s, a typical throughput might be more like 800 Mb/s (which is 80% of the theoretical maximum) that when further broken down into MB/s would be about 100 MB/s, which can be considered the maximum achievable performance. The monitoring element 16, which is connected to the network 22, in this example would show the achievable maximum at 800 Mb/s, and the current achievable given the specific configuration (which would depend upon the components and connections within the configuration) and an actual measured value below this. Measured over time, a variance for typical throughput could also be shown to give an overall impression of network usage. The monitoring element 16 either pulls the data from the network or it is periodically pushed onto the monitoring element from the relevant component(s).

The purpose of the monitoring is to provide feedback either directly to a user or administrator or to provide data that can be fed to a higher level process or application that will perform some sort of computer analysis of the performance measurements. If feedback is provided visually in real-time, then a user can see the current level of performance relative to the two absolute levels of the maximum achievable performance and the maximum performance given the current system configuration. If there is any underperformance, then this will be immediately obvious from the feedback being provided and it will also be obvious if the system performance is degrading over time. This will support the taking of pre-emptive action before any system performance degradation causes specific issues or failures.

The methodology discussed above of measuring performance can also be applied to databases. The examples given above, in general, focus on a single low-level component in a computer system (treating storage as a single black-box low-level component). Moving up from the hardware stack and into the application layer, the same principles of performance measurement can be applied to other system elements, but now there are more components to take into account. In the case of database performance, this is commonly measured by transactions per second. The achievable maximum for any database will depend on where the first bottleneck for that particular database might be and the workload being given to specific component.

For example, a first database might be particularly highly CPU intensive, so the bottleneck will be CPU load first, whereas a different database might be more memory intensive, so the bottleneck will be memory performance first. Each component in the system (CPU, memory, networking, storage and other components) must be known and measurable before it is possible to work out the achievable maximum performance for the number of transactions per second at which the specific database will be able to perform. Each individual implementation of a database will have a bottleneck that will depend on the hardware and software characteristics of the different components that make up the specific database.

A specified algorithm can be used to determine the overall performance measurement of a database, or it is also possible to simply take into account the achievable maximum performance of all of the components in the system, to work out the achievable maximum of the database. Ideally, this process would be followed back to derive the maximum performance expected from the database in its current configuration and then provide a measure of current performance, with an option to use a measurement of standard deviation in place as well. In this way complex systems such as databases can also have their performance monitored using the three measures of maximum achievable performance, maximum performance for current configuration and current performance.

The monitoring system and process described above can be used on more complex computing systems such as a so-called “Beowulf Cluster”, for example. A Beowulf Cluster is a set of distributed computer systems that are joined together to form a powerful super computer for the purposes of running large scale algorithms such as seismic processing or weather prediction. This computing environment provides an example of how to measure the maximum performance of such a set of systems (known as Rmax) and the maximum achievable performance (known as Rpeak). These values provide two of the three values needed in the system performance determination, the other value being some measure of the current performance.

Rpeak is calculated by multiplying the clock speed of the processors used (in Mhz) by the number of cores in the cluster by the number of instructions per clock cycle the CPU is able to perform. For example, a cluster of 1024 Intel based processors (such as Xeon) running at 3 Ghz which perform four instructions per clock cycle would have an Rpeak of 12.288 Tflops i.e. 1024×3000×4=12288000 flops per s. The standard industry benchmark for calculating Rmax is the unpack algorithm. This algorithm scales well and gives a measurement in Tflops of the performance of the cluster. This example shows how the principles of the illustrative embodiments can be applied to a set of computer systems as well as to the independent components or to high-level software in the application layer.

FIG. 5 gives an example of the visualisation of the determined performance measurements, as rendered by the monitoring element 16. The display device 20 of the monitoring element 16 shows a visual indication 24, the full height of which represents the maximum achievable performance (pmax) of the component being monitored. The central line 26 represents the maximum performance (pmaxconfig) that could be achieved given the current system configuration. The two arrows labelled “IN” and “OUT” represent the current performance (pcurr) for the component for two different metrics. This could be a fibre channel port with the two metrics being the input IO rate per second and the output IO rate per second.

The central visual indication 24 could be colour coded below the line 26 with red at the bottom moving through orange to green at the top, in order to provide instant visual feedback to a user who is viewing the display device 20. The arrows labelled “IN” and “OUT” may move in real-time as the monitored performance of the component changes. This allows the user to track the performance of the component over time. The user may also sec the line 26 move either up or down if configuration changes are made to the overall system and this can help to inform decisions concerning configuration changes and how they will impact individual components and the important metrics for those components.

The example of the display in FIG. 5 is such that the central bars produce a real-time display similar to a graphic equaliser and the “TN” and “OUT” arrows on either the side show read/write efficiency/throughput, and they can be arranged to change colour as they get closer to maximum performance. For a different component such as a cache, the colours would be the other way up, since low cache hits equates to poor performance of the cache. For some set ups, the arrows to the side would not be necessary or available, the cache example is one such example as there is only one main metric that is being measured for this component.

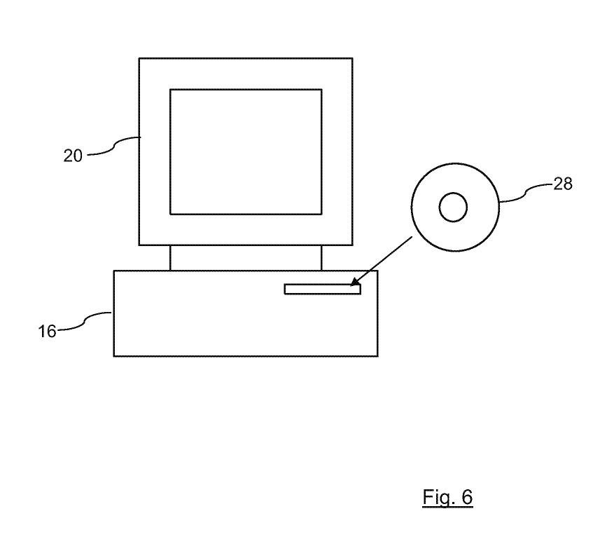

FIG. 6 shows the monitoring element 16 with its display device 20. The monitoring element can be a conventional desktop computer that is connected to each component that is being monitored. The connection to a component can be direct or indirect via a suitable network topology. A CD-ROM 28 is a computer readable medium that has stored thereon a computer program product. The computer program product comprises instructions for controlling the operation of the monitoring element 16. A user can operate the monitoring element 16 in order to see the visual indications that relate to each of the components that are being monitored and can in this way monitor the operation of the system, which is made up of the different components.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, hut not limited to, electro-magnetic, optical, or any suitable combination thereof. A computer readable signal medium may be any computer readable medium that is not a computer readable storage medium and that can communicate, propagate. or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A method of determining system performance in a system comprised of one or more components and a monitoring element, the method comprising for each component:
determining a maximum achievable performance (pmax) for the component for a specific metric;
determining a maximum performance (pmaxconfig) for the component for the specific metric, given the current system configuration;
determining a current performance (pcurr) for the component for the specific metric; and
providing the maximum achievable performance, maximum performance, and current performance for the component for the specific metric to the monitoring element.

2. A method according to claim 1, further comprising repeating the determining of the maximum achievable performance, maximum performance, and current performance for the component for a different metric.

3. A method according to claim 1, further comprising displaying a visual indication combining the maximum achievable performance, maximum performance, and current performance for the component.

4. A method according to claim 1, further comprising displaying a visual indication combining the maximum achievable performance, maximum performance, and current performance for the component for multiple metrics.

5. A method according to claim 1, wherein determining a current performance (pcurr) for the component for the specific metric comprises measuring component performance for the specific metric over a predetermined time period.

6. A system comprising of one or more components and a monitoring element connected to at least one component, wherein each component comprises a processor and a memory storing instructions which, when executed by the processor, cause the processor to:
determine a maximum achievable performance (pmax) for the component for a specific metric;
determine a maximum performance (pmaxconfig) for the component for the specific metric, given the current system configuration;
determine a current performance (pcurr) for the component for the specific metric; and
provide the maximum achievable performance, maximum performance, and current performance for the component for the specific metric to the monitoring element.

7. A system according to claim 6, wherein each component is further configured to repeat the determining of the maximum achievable performance, maximum performance, and current performance for the component for a different metric.

8. A system according to claim 6, wherein the monitoring element is configured to display a visual indication combining the maximum achievable performance, maximum performance, and current performance for a given component.

9. A system according to claim 7, wherein the monitoring element is further configured to display a visual indication combining the maximum achievable performance, maximum performance, and current performance for a given component for multiple metrics.

10. A system according to claim 6, wherein each component is configured, when determining a current performance (pcurr) for the component for the specific metric, to measure component performance for the specific metric over a predetermined time period.

11. A computer program product on a computer readable storage medium for determining system performance in a system comprised of one or more components and a monitoring element, the product comprising, for each component, instructions executable by a processor for:
determining a maximum achievable performance (pmax) for the component for a specific metric;
determining a maximum performance (pmaxconfig) for the component for the specific metric, given the current system configuration;
determining a current performance (pcurr) for the component for the specific metric; and
providing the maximum achievable performance, maximum performance, and current performance for the component for the specific metric to the monitoring element.

12. A computer program product according to claim 11, further comprising instructions for repeating the determining of the maximum achievable performance, maximum performance, and current performance for the component for a different metric.

13. A computer program product according to claim 11, further comprising instructions for displaying a visual indication combining the maximum achievable performance, maximum performance, and current performance for the given component.

14. A computer program product according to claim 11, further comprising instructions for displaying a visual indication combining the maximum achievable performance, maximum performance, and current performance, for the component for multiple metrics.

15. A computer program product according to claim 11, wherein the instructions for determining a current performance (pcurr) for the component for the specific metric comprise instructions for measuring component performance for the specific metric over a predetermined time period.

16. A method according to claim 1, wherein the component comprises a Fibre Channel port and wherein the specific metric comprises transmitted data rate per second, received data rate per second, transmitted output transactions per second, received input transactions per second, total data rate per second, or total input/output transactions per second.

17. A method according o claim 1, wherein the component comprises a network and wherein the specific metric comprises throughput.

18. A method according to claim 4, wherein displaying the visual indication comprises:
displaying the visual indication such that the full height of the visual indication represents the maximum achievable performance (pmax);
displaying a line on the visual indication such that the line represents the maximum performance (pmaxconfig) that could be achieved given the current system configuration; and
displaying an indicator with respect to the visual indication such that the indicator represents the current performance (pcurr) of the component.

19. The method according to claim 18, wherein the visual indication is color coded.

20. The method according to claim 18, wherein the indicator moves in real-time as the monitored performance of the component changes.
